(19) United States
(12) Patent Application Publication
(10) Pub. No.: US 2004/0036560 A1
(43) Pub. Date: Feb. 26, 2004

(54) Coaxial tube elbow and method of manufacturing the pipe elbow

(76) Inventors: Tadashi Higuchi, Osaka (JP); Yoshio Tsuchizaki, Osaka (JP); Toyohisa Takano, Osaka (JP); Motokazu Nagasawa, Hyogo (JP); Masao Ryoma, Kishiwada-shi, Osaka (JP); Hiroshi Harima, Kobe-shi, Hyogo (JP)

Correspondence Address: SMITH, GAMBRELL & RUSSELL, LLP, 1850 M STREET, N.W., SUITE 800, WASHINGTON, DC, 20036, US

(21) Appl. No.: 10/416,765

(22) PCT Filed: Nov. 13, 2001
(86) PCT No.: PCT/JP01/09888

(30) Foreign Application Priority Data
Nov. 14, 2000 (JP) 2000-346483

(51) Int. Cl. H01P 1/00

(52) U.S. Cl. 333/260; 333/33

(57) ABSTRACT

A coaxial tube elbow has an external electric conductor tube (10) housing an internal electric conductor (20) inside and bend sections (12, 21D) formed by bending the external electric conductor tube and the internal electric conductor at a predetermined angle. The vertical section of the external electric conductor tube (10) is an arc shape at the bend section (12). The vertical section of the bend section (21D) of the internal electric conductor (20) is preferably of a partially notched arc shape. In the manufacturing of the external electric conductor tube (10), low melting point metal is filled into the external electric conductor tube of a straight shape and then the tube is bent in a metal mold. After the bending, low melting point metal is melt and removed by heating, whereby a bent external electric conductor tube (10) can be obtained. Thus the coaxial tube elbow with fewer parts allowing assembly without the use of brazing can be obtained.

### TECHNICAL FIELD

The present invention relates to a coaxial tube elbow suitable for high-frequency signal power transmission for a particle accelerator or a broadcasting station and an external electric conductor tube for an elbow, and a method for manufacturing an external electric conductor tube for an elbow.

### BACKGROUND ART

When the direction of an installation route of a transmission line is to be changed between a transmitter in a broadcasting station and an antenna, an elbow as shown in FIG. 13 is used. The elbow has a double structure which is constituted from an external electric conductor tube 70 and an internal electric conductor 80 enclosed therein, and is provided with bend sections 71 and 81 that are bent by approximately 90°. Silver brazing is utilized for both external electric conductor tube 70 and internal electric conductor 80 for the formation of bend sections 71 and 81.

Bend section 71 of the external electric conductor tube is formed from two pipes each having a slant-cut end which forms an angle of approximately 45° and which cut sections are abutted and joined through silver brazing. Further, internal electric conductor 80 includes a first electric conductor tube 82 having a solid section at one end, a connecting block 83 having a bolt hole, and a second conductor tube 84 having a solid section at one end and a bolt hole in the solid section. First electric conductor tube 82 and connecting block 83 are joined by silver brazing. Connecting block 83 and second electric conductor tube 84 are joined by screwing a bolt 90 into the bolt hole.

Internal electric conductor 80 is held coaxially in external electric conductor tube 70 with an insulating spacer 100 therebetween. An elbow similar to the above-described elbow is disclosed also in Japanese Utility Model Laying-Open No. 2-64201.

The coaxial tube elbow as described above, however, has the following problems.

\mathring{1} A Complicated Assembly Process Makes the Quality of the Product Fluctuate Depending on the Skill of an Operator.

For the assembly of the conventional elbow, many steps are required including “slant cut of the external electric conductor tube→milling of the cut section→application of flux to sections to be joined (cut sections)→silver brazing with torch→acid cleaning (pickling)→washing with water”. As the brazing, in particular, is performed by hand, it can cause the fluctuation of the quality of the resulting product depending on the level of the skill of the operator. In addition, corrosive flux is employed in silver brazing to dissolve the wax material. It is necessary to remove (wash out) remnant flux after the completion of brazing process. Thus, silver brazing requires a significant workload on the side of an operator and is costly.

\mathring{2} The Number of Parts is Large.

As the conventional elbow needs two parts for the external electric conductor tube and three parts for the internal electric conductor, it is necessary to fabricate many parts for the elbow, which leads to the increase in production cost.

\mathring{3} Possibility of Lower Material Strength.

Silver brazing is performed through torch brazing, in which heating temperature is approximately 800° C., if low-temperature silver brazing is employed. Generally, copper (copper alloy), which has an excellent heat conductivity, is used as the material for the external electric conductor tube and an adjacent region including brazed section are heated up to approximately 800° C. As a result, copper (copper alloy) is annealed and the material strength is lowered. Particularly, if the quality of the material is classified as “½H” according to JIS 3100H before the brazing, it can be classified as “0” after the brazing.

Hence, a main object of the present invention is to provide a coaxial tube elbow with a fewer parts, which can be assembled without brazing process.

Further, another object of the present invention is to provide, for a coaxial tube elbow, an external electric conductor tube which can be formed to have a bend section with a small arc radius without the use of brazing process and a method for manufacturing the same.

### DISCLOSURE OF THE INVENTION

The present invention achieves the above mentioned objects by making the shape of a vertical section of a bend section of an external electric conductor tube arcuate.

In other words, the coaxial tube elbow according to the present invention is a coaxial tube elbow having an external electric conductor tube housing an internal electric conductor, and a bend section where the external electric conductor tube and the internal electric conductor are bent at a predetermined angle, and is characterized in that the vertical section of the bend section of said external electric conductor tube is arcuate.

In the conventional elbow, the external electric conductor tube joined by brazing is employed. This is because when a tool such as a bender bends a metal tube, it is difficult to bend the metal tube to an arc shape while maintaining a hollow inside the metal tube. The present invention, by providing a method for manufacturing an external electric conductor tube described later, allows the bending of a metal tube into an arc shape without damaging the hollow condition.

The external conductor tube in the elbow according to the present invention has a seamless integrated structure which is smooth from one end to another end. Though two metal tubes are conventionally joined by brazing, the brazing process can be eliminated when the number of tube part is one.

The angle of the bend section is not limited in particular. Though usually the angle is 90°, those with 135° are sometimes used. The angle of the bend section means an angle formed by an axis of a straight section of the external electric conductor tube and an axis of a straight section of the internal electric conductor, the straight sections are located next to the bend section.

An arc radius of the bend section means an arc radius of a central axis at the bend section of the external electric conductor tube. Generally, as the internal electric conductor is coaxially arranged with the external conductor tube, an arc radius of the bend section of the internal electric conductor is same with the arc radius of the external electric conductor tube. Here, though the external electric conductor tube and the internal electric conductor need to be coaxial at the straight sections extending from both sides of the bend section, they do not need to be coaxial at the bend section itself.

When the bend section of the external electric conductor tube and the bend section of the internal electric conductor are both formed in an arcuate shape, if the arc radius of the external electric conductor tube is longer than 110 mm, a predetermined electric characteristic can be obtained, whereas when the radius is not longer than 110 mm, the electric characteristic is degraded as is obvious from the result of simulation described later. When the arc radius of the external electric conductor tube is not more than 110 mm, the electric characteristic can be improved to a satisfactory level through the formation of a predetermined notch in the internal electric conductor.

The external electric conductor tube used in the elbow of the present invention can be employed mainly for 50Ω coaxial tubes with a size corresponding to coaxial tubes such as WX-20D, WX-39D, WX-77D specified in the standard for 50Ω coaxial tube in the Standard of Electronic Industries Association of Japan EIAJ TT-3004. In other words, the outer diameter of the external electric conductor tube is approximately 20 to 80 mm. In general, as the outer diameter of the external electric conductor tube increases, it becomes harder to retain the hollow therein during bending. An elbow satisfying a predetermined electric characteristic can be formed if the external electric conductor tube is of the size as described above. However, it is needless to say that the present invention can be applied for the external electric conductor tube with the size of outer diameter which falls outside the range as described above.

On the other hand, it is favorable that the vertical section of the bend section of the internal electric conductor is formed in the shape of a partially notched arc to secure the electric characteristic of the elbow. In particular, in the case where the bend angle is 90°, provided that the straight sections extending from each of the both sides of the bend section are termed as a vertical section and a horizontal section, a favorable notch shape would be determined as follows (FIG. 2).

A point located away from a center O of the arc by a predetermined distance in a horizontal direction is indicated by character P, a point located away from the center O of the arc by a predetermined distance in a vertical direction is indicated by character Q, and character R indicates a diagonal point of the center O of the arc on a rectangle formed with the line OP (OQ) as one side. Then, the bend section of the internal electric conductor can be notched along a slant line X running orthogonally to a slant line OR and running on diagonal point R. The depth of the notch is determined based on the adjustment of the distance OP (OQ).

Voltage standing wave ratio (VSWR) according to “Specification on Testing Method of Power Supply Line Formed with Coaxial Tube and Flexible Coaxial Tube” BSS 01-2005 (Nihon Hoso Kyokai: 1982) is employed as an index of electric characteristic. According to the specification, VSWR should not be more than 1.03 in the rated frequency range when the number of the elbows is not more than three. The value of VSWR can be sought by dividing the absolute value of maximum voltage of a standing wave on the transmission line by the absolute value of minimum voltage.

Further, characteristic impedance Z₀ of the coaxial tube, which is one of the electric characteristics of the elbow, can be sought by the following equation, and determines the sizes, such as the inner diameter of the external electric conductor tube and the outer diameter of the internal electric conductor, to obtain a certain result, for example, Z₀=50Ω.

$${Z}_{0} = \frac{138.1}{\sqrt{ϵ}} {log}_{10} \frac{b}{a} ( Ω ) \qquad Formula 1$$

a: the outer diameter of the internal electric conductor

b: the inner diameter of the external electric conductor tube

ε: permittivity between the external electric conductor tube and the internal electric conductor

Preferably the internal electric conductor is formed from two parts. For example, a straight conductor and a J-shaped conductor having a bend section at one end and a straight section at another end may be connected via a bolt. The bend section can be formed with a known bending technique, for example, with a bender. The J-shaped conductor is a part with a solid section at one end and the bend section is formed in the solid section. The number of the parts is decreased as there are only two parts and the silver brazing process is eliminated from the assembly procedure as the bolt is used instead, whereby the workability of elbow assembly can be greatly improved.

The manufacturing method of the external electric conductor tube according to the present invention is characterized in that the method has the following steps A to C.

A: a step to fabricate a filler by filling an external electric conductor tube with a low-melting point material;

B: a step to mount the filler to a metal mold having a bending depression formed to have a predetermined angle and a straight-shaped depression leading to the bending depression;

C: a step to mold the filler into a shape corresponding to the bending depression through the movement of said filler from the straight-shaped depression to the bending depression; and

D: a step to remove the low-melting point material from the external electric conductor tube by heating the filler taken out from the metal mold and melting the low-melting point material.

In the step A, it is suitable to use, as a practical process to put the low-melting point material into the external electric conductor tube, a process to melt the low-melting point material and to inject the same into the external electric conductor tube. Thus, it is possible to fill the low-melting point material into the external electric conductor tube tightly.

In the step B, the filler is mounted onto the straight depression of the metal mold. This is because at this point, the filler is still in the straight form.

In the step C, the movement of the filler from the straight depression to the bending depression is favorably performed by pushing a piston extruder into the metal mold from one end of the straight depression, thereby pressing the filler by the extruder.

After the step D, if the removal of the low-melting point material is not sufficient, it is preferable that acid cleaning followed by water washing is performed to remove the remaining low-melting point material. Thus, the internal surface of the external electric conductor tube becomes smooth, providing the external electric conductor tube with excellent electric characteristic.

A preferable material as the low-melting point material has a lower melting point than the material used for the external electric conductor tube, has a suitable flowability, and hardness which allows the retention of the material inside the tube during the molding of the filler inside the metal mold such that the space inside the external electric conductor tube would sufficiently be secured.

Generally, materials such as copper, copper alloy, aluminum, aluminum alloy are utilized for the external electric conductor tube. As the melting point of copper is 1084.5° C. and the melting point of aluminum is 660.4° C., material with lower melting point than these temperatures are usable as low-melting point material.

However, at the time of filling and removal of the low-melting point material, the external electric conductor tube is heated to a temperature not lower than the melting point of the low-melting point material and lower than the melting point of the external electric conductor tube material. Hence, the heat temperature at these points is preferably a temperature that would not cause annealing of the external electric conductor tube which would lower the strength. It is expected that a temperature which would not cause annealing of copper is approximately equal to or lower than 600° C. and a temperature which would not cause annealing of aluminum is approximately equal to or lower than 450° C. In general consideration of above mentioned facts, the most suitable material as the low-melting point material is low-melting point metal including lead (whose melting point is 327.5° C.), in particular. Other than lead, plastic material such as high-density polyethylene (HDPE), polyethylene, and polypropylene are expected to be usable.

According to the manufacturing method of the present invention, a seamless external electric conductor tube can be obtained. Hence, the brazing process can be eliminated and the fluctuation in the quality of product caused by the different level of operators can be avoided. Particularly because the external electric conductor tube is bent by the metal mold, the material strength can be improved through work hardening caused at the time of bending. For example, if the material is classified as “0” according to JIS 3100H before the bending, the quality can be improved to about classification “½H” after the bending.

### BRIEF DESCRIPTION OF THE DRAWINGS

FIG. 1 is a vertical section of a coaxial tube elbow according to the present invention.

FIG. 2. is a drawing provided by way of explanation of a process of partial notching of an internal electric conductor.

FIG. 3 is a drawing showing a condition of a filler before the bending according to a method for manufacturing an external coaxial tube according to the present invention.

FIG. 4 is a drawing showing a condition of the filler after the bending according to the method for manufacturing the external coaxial tube according to the present invention.

FIG. 5 is a graph showing the relation between VSWR and a bend radius of an elbow having an internal electric conductor with an arc-shaped bend section.

FIG. 6 is a vertical section of an elbow according to the present invention having a flange at ends.

FIG. 7 is a graph showing the relation between VSWR and an amount of notch CL of an elbow having an internal electric conductor with a partially notched arc-shaped bend section at 470 MHz.

FIG. 8 is a graph showing the relation between VSWR and an amount of notch CL of an elbow having an internal electric conductor with a partially notched arc-shaped bend section at 510 MHz.

FIG. 9 is a graph showing the relation between VSWR and an amount of notch CL of an elbow having an internal electric conductor with a partially notched arc-shaped bend section at 570 MHz.

FIG. 10 is a graph showing the relation between VSWR and an amount of notch CL of an elbow having an internal electric conductor with a partially notched arc-shaped bend section at 630 MHz.

FIG. 11 is a graph showing the relation between VSWR and an amount of notch CL of an elbow having an internal electric conductor with a partially notched arc-shaped bend section at 710 MHz.

FIG. 12 is a graph showing the relation between VSWR and an amount of notch CL of an elbow having an internal electric conductor with a partially notched arc-shaped bend section at 770 MHz.

FIG. 13 is a vertical section of a conventional coaxial tube elbow.

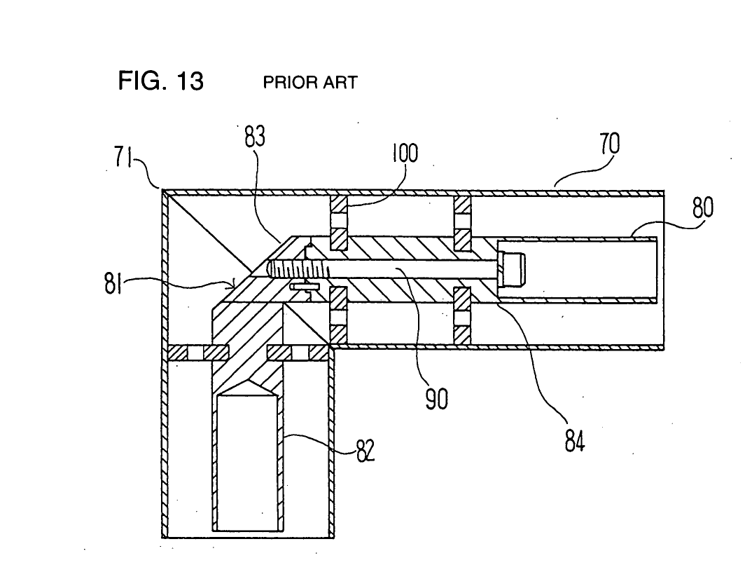

FIG. 14 is a vertical section of a coaxial tube elbow according to another embodiment of the present invention.

### BEST MODES FOR CARRYING OUT THE INVENTION

Embodiments of the present invention will be described hereinafter.

(Structure)

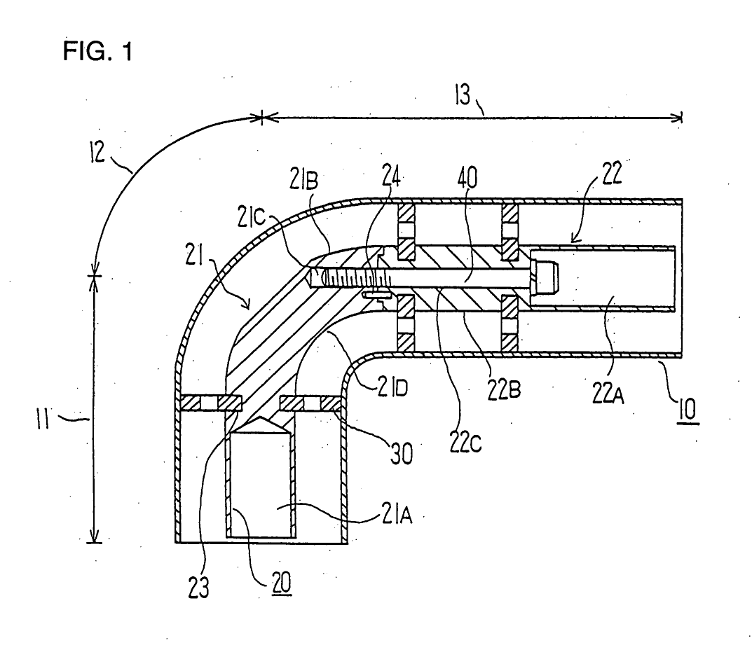

FIG. 1 is a vertical section of a coaxial tube elbow according to the present invention. Here, a description will be given based on an example of an elbow with an angle of 90°. The elbow is of a structure including an external electric conductor tube 10 coaxially holding an internal electric conductor 20 with an insulating spacer 30 therebetween.

External electric conductor tube 10 is formed from a seamless copper tube. The tube has openings at both ends and a bend section 12 is formed approximately at the middle of the tube. Bend section 12 leads to a vertical section 11 and a horizontal section 13 which are formed as straight sections for the connection to other coaxial tubes.

On the other hand, internal electric conductor 20 is formed of a J-shaped conductor 21 and a straight conductor 22, the two parts connected by a bolt 40. Conductors 21 and 22 are both formed to have hollow sections 21A and 22A at one end and solid sections 21B and 22B at another end, respectively. The solid sections of these conductors are abutted and joined. Screwing of bolt 40 achieves the joining. Hence, a bolt hole 21C is formed on an end surface of the solid section of J-shaped conductor 21 and a bolt hole 22C penetrating in the axial direction is formed in solid section 22B of the straight conductor. Solid section 21B of the J-shaped conductor is molded into a bend section 21D and the molding is achieved through giving it a bend of a predetermined radius using a tool, such as a bender.

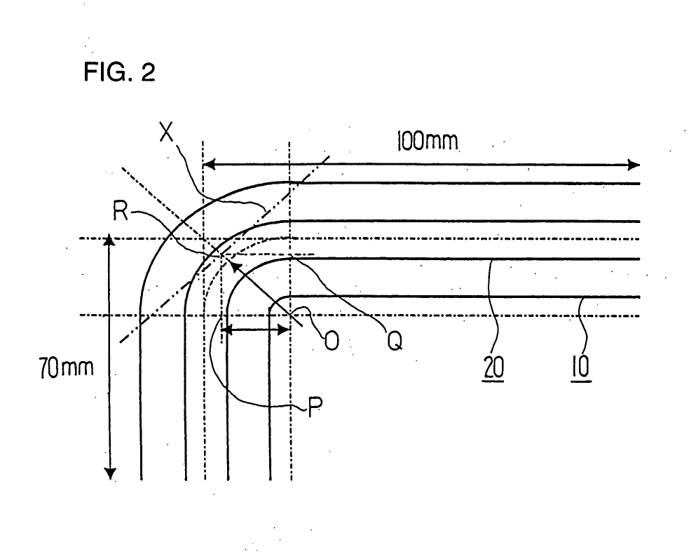

The bend section is formed into a partially notched arc shape. This is for securing the electric characteristics. In this embodiment, the arc of the bend section is notched along a slant plane. As shown in FIG. 2, character P indicates a point away from the center O of the arc by a predetermined distance in a horizontal direction, character Q indicates a point away from the center O the arc by a predetermined distance in a vertical direction, and character R indicates a diagonal point across the center O of the arc on a rectangle which is formed with OP and OQ as sides. Here, the bend section of the internal electric conductor is partially notched along a slant line X which runs orthogonally to a slant line OR and runs on diagonal point R.

Bolt hole 21C may be exposed on the notched surface. However, the electric characteristics considered, it is not preferable that a top end of bolt 40 extrudes from the notched surface.

Further, conductors 21 and 22 have an annular groove 23 on the outer periphery of the solid sections to allow the fitting of insulating spacer 30. Polytetrafluoroethylene is used for insulating spacer 30.

In addition, a pin 24 is fitted onto the joint surface of J-shaped conductor 21 and straight conductor 22 as a detent to prevent the rotation of straight conductor 22 with regard to J-shaped conductor 21.

Here, an elbow is fabricated corresponding to 50Ω coaxial tube WX-39D according to the standard of Electronic Industries Association of Japan (EIAJ) TT-3004. The dimension of each part is as follows.

External electric conductor tube

outer diameter: 41.3 mm

inner diameter: 38.8 mm

Internal electric conductor

outer diameter: 16.9 mm

inner diameter of the hollow section: 14.9 mm

length from the opening of the horizontal section to a point where the axis of the horizontal section and the axis of the vertical section intersects: 100 mm

The length from the opening of the vertical section to a point where the axis of the vertical section and the axis of the horizontal section intersects: 70 mm

Radius of the arc at the bend section: 30 mm

(Assembly Process)

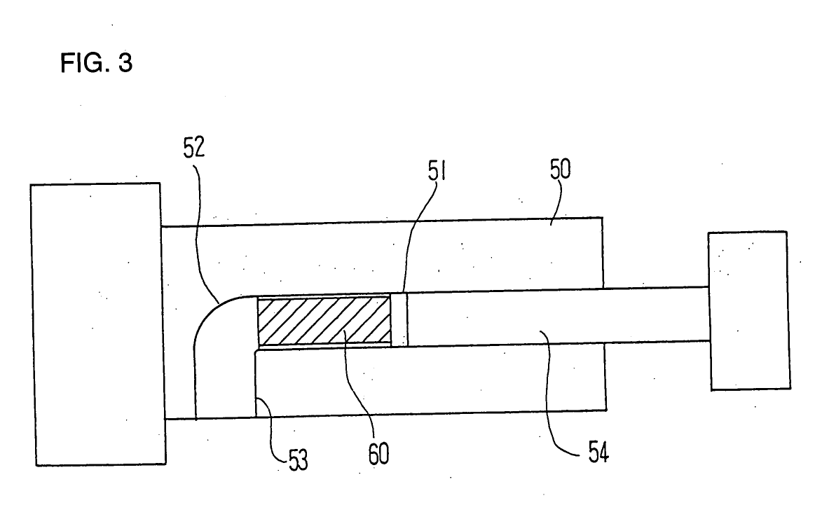

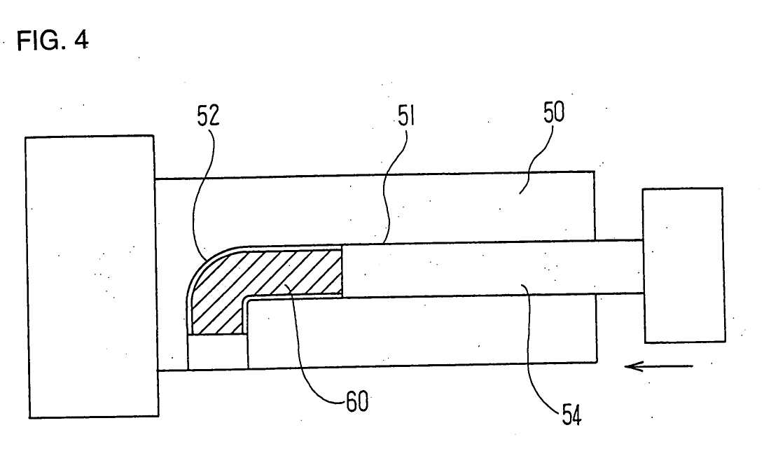

The coaxial tube elbow as described above is assembled with the external electric conductor tube which is manufactured according to a method as shown in FIGS. 3 and 4. A method for manufacturing the external electric conductor tube will be described hereinafter.

First, a straight-shaped copper tube is prepared, set into a vertically standing position and a bottom section is formed at a lower opening section. Then melt lead is injected from an upper opening of the copper tube, whereby a filler 60, a copper tube filled with lead, is provided.

Then the filler is mounted onto a metal mold. A metal mold 50, as shown in FIG. 3, has a depression extending from a straight depression 51, a bending depression 52 and to a straight depression 53. Bending depression 52 bends at a bend angle of 90°. Filler 60 is mounted onto one straight depression 51 of the metal mold. Then metal mold 50 is closed and an extruder 54 is inserted into straight depression 51.

Then as shown in FIG. 4, pressure of a predetermined level is applied onto extruder 54 thereby moving filler 60 from straight depression 51 to bending depression 52. With this movement, filler 60 is made bent along bending depression 52.

After the bending of filler 60, filler 60 is taken out from metal mold 50 and heated to a temperature not lower than the melting point of lead and not higher than the melting point of copper, thereby melting and removing lead from the copper tube. At this step, the temperature for heating is approximately 400° C. Following the process as described above, a bent external electric conductor tube can be formed.

In some cases, lead cannot be completely removed even by the melting. Hence, acid cleaning and water cleaning are performed on the copper tube to completely remove remaining lead.

After the completion of the external electric conductor tube, insulating spacers are attached to a J-shaped conductor and a straight conductor which have been formed separately. Then the J-shaped conductor and the straight conductor are inserted from openings of the external electric conductor tube, respectively, so that the end surfaces of the solid sections are abutted and screwed with a bolt to finish the assembly.

Further, coaxial tube elbow corresponding to 50Ω coaxial tube WX-77D (inner diameter 76.9 mm, arc radius 50 mm) and WX-20D (inner diameter 19.94 mm, arc radius 14 mm) according to the standard of Electronic Industries Association of Japan (EIAJ) TT-3004 are fabricated in addition to the coaxial tube elbow with the external electric conductor tube as described above. Either of these tubes satisfy predetermined electric characteristics and the external electric conductor tube without any problem in appearance is obtained.

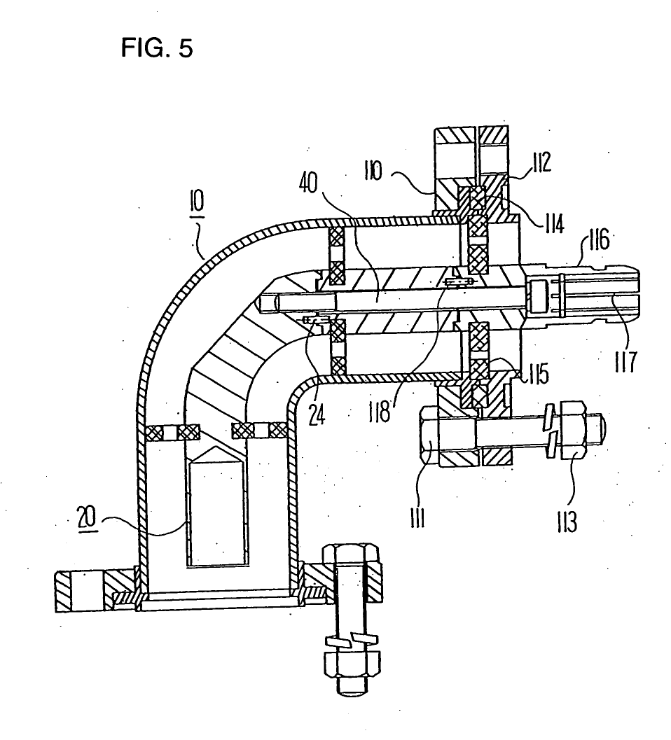

Further, as shown in FIG. 5, for an outdoor use, a flange 110 is formed at the end of the elbow. Flange 110 is secured to each opening of external electric conductor tube 10 of the elbow. Flange 110 is a round plate with a bolt 111 penetrating its outer periphery. A similar flange is provided to a coaxial tube (not shown) adjacent to the elbow, and flange 110 of the elbow and the flange of the adjacent coaxial tube are connected by a bolt 111 and a nut 113 with intervening plate 112 therebetween. On a joint surface of intervening plate 112 and flange 110, a packing 114 is fitted to prevent a water leak into the external electric conductor tube. Further, an insulating spacer 115 is inserted between internal electric conductor 20 at a position corresponding to the joint surface of intervening plate 112 and flange 110.

In addition, at an end of internal electric conductor 20, a male coupler 116 is formed. Male coupler 116 is formed to have a plurality of slits 117's running along the axial direction and being arranged along the peripheral direction whereby the insertion of the female coupler (not shown) of the adjacent coaxial tube is facilitated as the size of external diameter of male coupler 116 can decrease accordingly. Internal electric conductor 20 of this example includes three parts in total. Detent pins 24 and 118 are located at the position where these parts are joined. These three parts are all integrated via bolt 40.

Thus, the present invention can be applied to both indoor elbow and outdoor elbow.

### TEST EXAMPLE 1

The electric characteristic of the elbow corresponding to 50Ω coaxial tube WX-39D of the standard of Electronic Industries Association of Japan (EIAJ) TT-3004 was evaluated through simulation. Here, it is assumed that the external electric conductor tube and the internal electric conductor are coaxial and the bend sections thereof are both formed into an arc shape. The section of each bend section is held to an approximately perfect circle shape for both external electric conductor tube and the internal electric conductor. This means that there is no notch in the bend section.

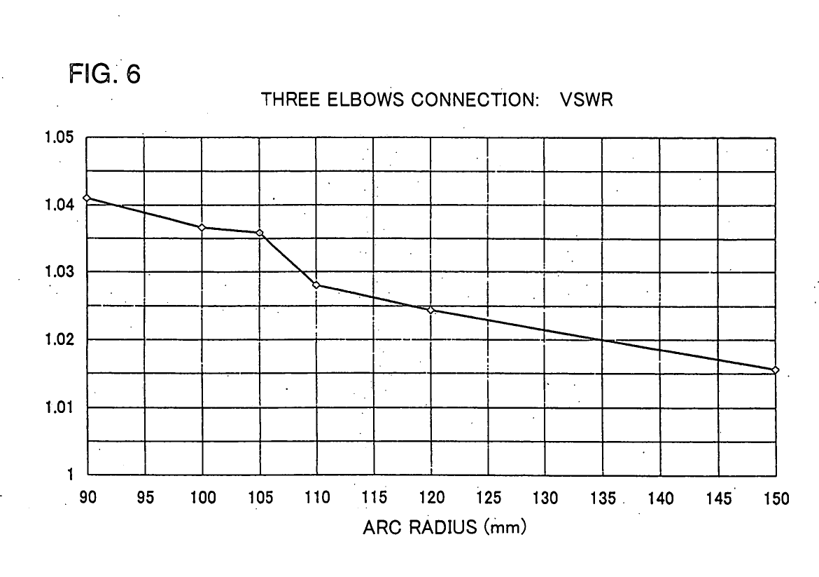

First, using the elbows with different bend radius, change in VSWR was evaluated according to Japan Broadcasting Association “Specification on Test Method for a Power Line Made from Coaxial Tube and Flexible Coaxial Tube” BSS 01-2005 (1982). According to this BSS specification, VSWR is required to be not more than 1.03 in the rated frequency range when equal to or less than three elbows are connected. The measurement of VSWR is performed by connecting a voltage standing wave ratio measurement device to one end of a test sample and connecting a standard load resistance to another end and generating a progressive wave from the voltage standing wave ratio measurement device. Progressive wave is divided by the test sample into reflected wave and passing wave which passes through standard load resistance. Through the detection and operation of this reflected wave by the voltage standing wave ratio measurement device, VSWR can be sought. Because of the interference between the progressive wave and the reflected wave, standing wave is produced, and less reflected wave makes VSWR closer to 1. The test is performed at the interval of 20 MHz in the range of frequency from 470 to 770 MHz for every different bend radius and a worst value from all sought values of VSWR is set as a VSWR value for a particular bend radius. The result of the test is shown in the graph of FIG. 6.

As is obvious from the graph of FIG. 6, when the bend radius is more than 110 mm, the standard of BSS specification is satisfied. However, it can be seen that when the bend radius is not more than 110 mm, a predetermined electric characteristic cannot be obtained.

### TEST EXAMPLE 2

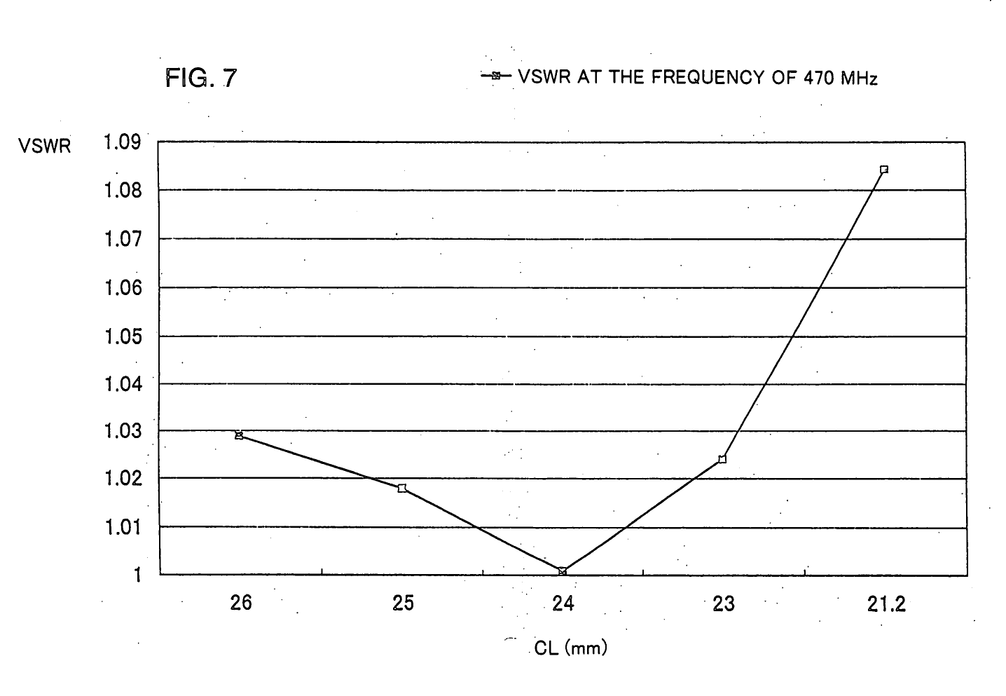

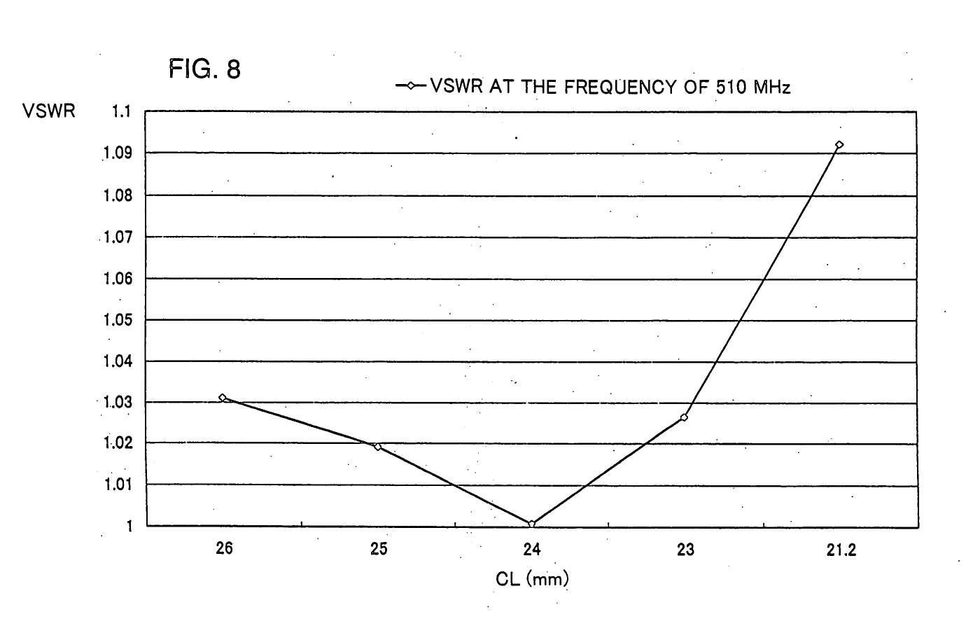

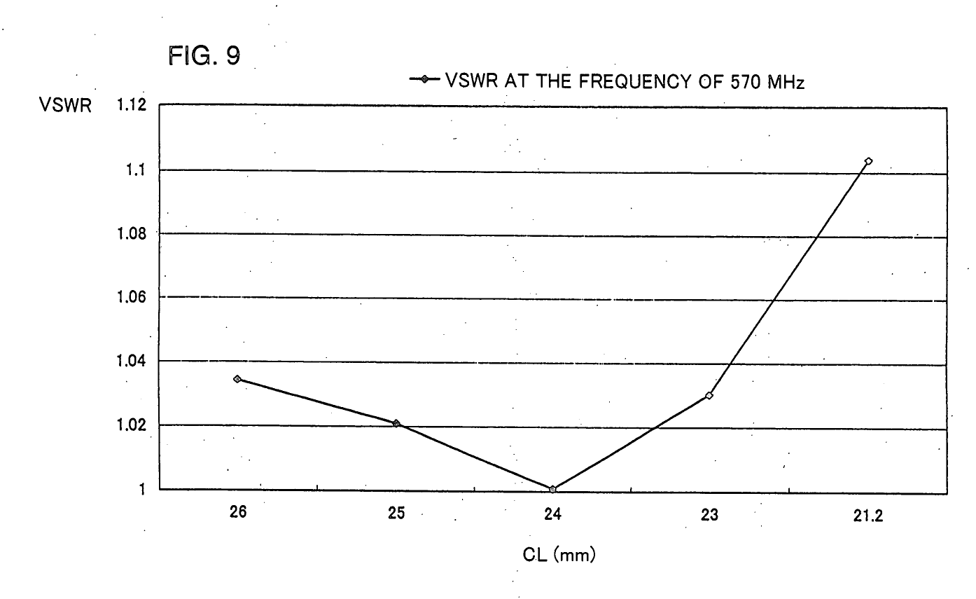

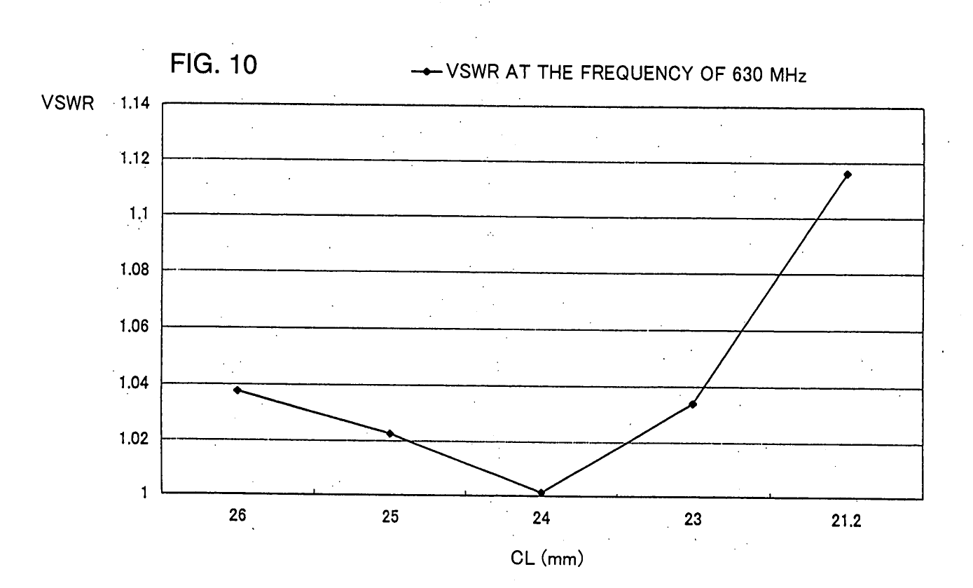

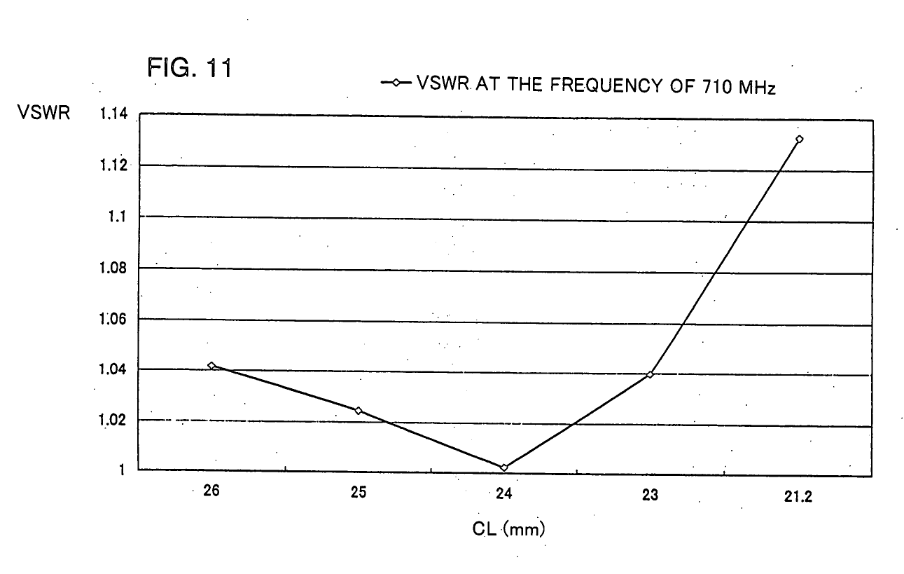

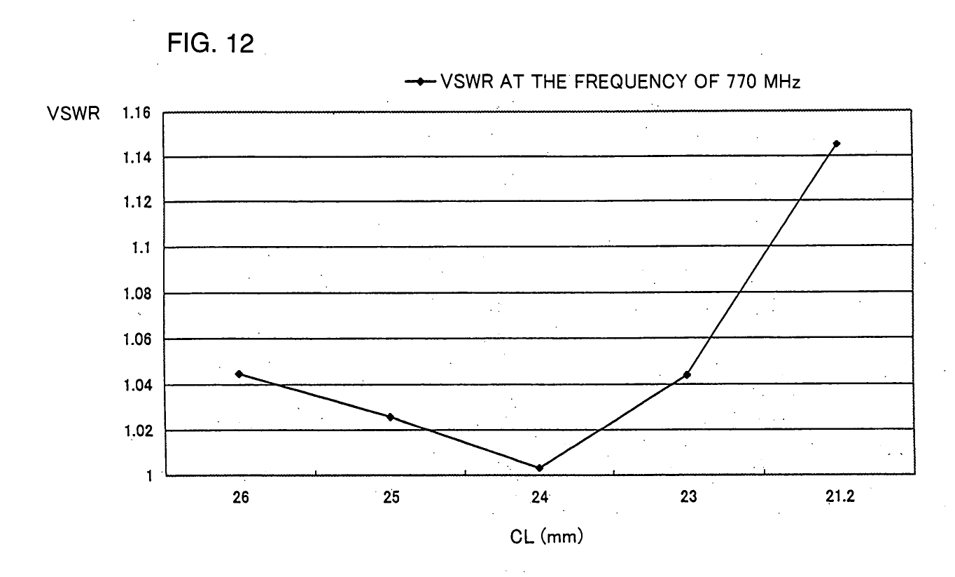

Next, based on the result of the Test Example 1, the relation between frequency and VSWR was evaluated with the bend section of the internal electric conductor partially notched so that the predetermined electric characteristic could be obtained even if the bend radius of the bend section was not more than 110 mm. The arc radius of the bend section used for the test is 30 mm. The shape of the notch is, as described in relation to FIG. 2, formed by cutting the arc of the bend section in a slant direction, and the notch is formed in five different sizes so that the length of OP (OQ) is 26, 25, 24, 23, 21.2 mm, respectively. In FIGS. 7-12, the relation between the size of the notch (indicated as CL in each figure) and VSWR is shown for each frequency.

As is obvious from these graphs, for any frequencies, the result was most favorable when CL is 24 mm and the second best result was obtained when CL is 25 mm. When CL is 26 or 23 mm, VSWR exceeds 1.03 at some frequencies proving to be unfavorable. Hence, the suitable dimension of the notch is, for any frequency range, expected that CL be approximately from 23.5 to 25 mm.

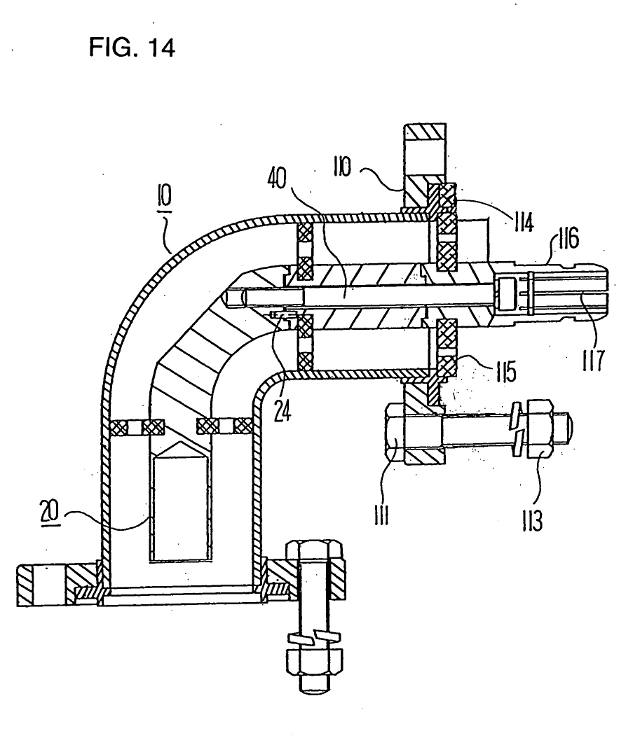

FIG. 14 is a vertical section of a coaxial tube elbow according to another embodiment of the present invention. The coaxial tube elbow of FIG. 14 is same with the coaxial tube elbow of FIG. 5 except the points specifically described below and same or corresponding portions will be given a same reference number and the description thereof will not be repeated. With reference to and in comparison of FIGS. 5 and 14, the embodiment does not have intervening plate 112 as is employed for the coaxial tube elbow of FIG. 5. Further, male coupler 116, slit 117, pin 118 and a part prevented from rotating are integrated into one part. With this structure, the number of parts is reduced allowing the manufacturing at lower cost. Further, in the device of FIG. 5, with regard to the internal electric conductor, two conductors are in contact via a pin 118. When the dimension of the conductor is not exact, a poor contact happens, which leads to a local heat generation. However, with the integration according to the embodiment, the number of contact points decreases whereby the risk of trouble caused by the heating can be lessened. Further, through the elimination of intervening plate 112, weight reduction (10% reduction) is allowed.

Industrial Applicability

As described above, the coaxial tube elbow or the external electric conductor tube for an elbow according to the present invention enjoy the following effects.

\mathring{1} Easy assembly or manufacturing is allowed with the elimination of silver brazing. Hence, the fluctuation in product quality caused by the difference in the level of the skill of the operator is eliminated and the degradation of the strength caused by the annealing of the material can be prevented.

\mathring{2} The number of parts can be reduced.

\mathring{3} With easier assembly and fewer parts, as described above, costs can be reduced.

\mathring{4} In particular, with an elbow having the internal electric conductor with the bend section shaped to have linear and partial notches, a predetermined electric characteristic can be surely satisfied.

The method for manufacturing the external coaxial tube of the present invention also allows an easier manufacturing without the use of silver brazing. Further, as the bend section is formed by a plastic working using a metal mold, material strength can be enhanced through work hardening.

1. A coaxial tube elbow having an external electric conductor tube (10) housing an internal electric conductor (20) therein, and a bend section (21D) formed from the external electric conductor tube and the internal electric conductor bent to a predetermined angle, the coaxial tube elbow characterized in that
said external electric conductor tube (10) has a vertical section of an arc shape at the bend section.

2. The coaxial tube elbow according to claim 1 characterized in that the radius of the arc is equal to or less than 110 mm.

3. The coaxial tube elbow according to claim 1 characterized in that said internal electric conductor (20) has a vertical section of a partially notched arc shape at the bend section (21D).

4. An external electric conductor tube for a coaxial tube elbow characterized in that a vertical section of a bend section (21D) is of an arc shape and a radius of the arc is equal to or less than 110 mm.

5. A method for manufacturing an external electric conductor tube, characterized in that the method including the steps of:
obtaining a filler formed by an external electric conductor tube (10) filled with a low melting point material;
mounting the filler onto a metal mold having a bending depression formed at a predetermined angle and a straight depression adjacent to the bending depression;
forming said filler into a shape corresponding to the bending depression through a movement of said filler from the straight depression to the bending depression; and
removing the low melting point material from inside external electric conductor tube (10) by heating the filler removed from the metal mold and melting the low melting point material.

6. The method for manufacturing the external electric conductor tube according to claim 5, characterized in that the low melting material is lead.
